(19) United States
(12) Patent Application Publication
(10) Pub. No.: US 2025/0157716 A1
(43) Pub. Date: May 15, 2025

(54) INTEGRATED DIFFERENTIAL MODE AND COMMON MODE INDUCTOR

(71) Applicant: Vacon Oy, Vaasa (FI)

(72) Inventors: Vesa Väisänen, Vaasa (FI); Harri Kaivo-oja, Vaasa (FI); Arttu Hautanen, Vaasa (FI)

(21) Appl. No.: 18/929,022

(22) Filed: Oct. 28, 2024

(30) Foreign Application Priority Data
Nov. 9, 2023 (DE) 102023131123.9

(51) Int. Cl. H01F 27/10; H01F 27/24

(52) U.S. Cl. CPC H01F 27/10; H01F 27/24

(57) ABSTRACT

An integrated differential mode and common mode inductor, which is preferably used for an active front end converter LC(L) filter or frequency converter sine filter. The inductor includes an internal inductor core and inductors arranged around an external inductor core, wherein the inductor core includes at least one cooling fluid conduit

### CROSS-REFERENCE TO RELATED APPLICATION

This application claims foreign priority benefits under 35 U.S.C. § 119 to German Patent Application No. 102023131123.9 filed on Nov. 9, 2023, the content of which is hereby incorporated by reference in its entirety.

### TECHNICAL FIELD

The present invention pertains to an integrated differential mode and common mode inductor, which is preferably used for an active front end converter LC(L) filter or frequency converter sine filter. The inductor comprises an internal inductor core and inductors arranged around an external inductor core, wherein the inductor core comprises at least one cooling fluid conduit.

### BACKGROUND

High power density inductors are known from the art and typically combine differential and common mode inductances. They are used in e.g. active front end converter LC(L) filters or motor inverter sine filters.

Typical problems associated with such inductors are their relative mechanical complexity and their intricate cooling requirements.

### SUMMARY

The aim of the present invention is to provide an improved inductor, with increased liquid cooled AFE common mode filtering capability and the same or a reduced mechanical footprint compared to the known solutions. The presently described inductor may therefore function without e.g. additional CM inductance. The present invention should also provide a simplified liquid cooling structure compared to known solutions, allowing better cooling of the inductor centre part.

This aim is achieved by an integrated differential mode and common mode inductor according to claim 1. Preferable embodiments are subject to the dependent claims. The integrated differential mode and common mode inductor, or integrated inductor for short, is preferably provided for an active front end converter LC(L) filter or frequency converter sine filter. It comprises an internal inductor core situated within an external inductor core. Inductor coils or put simply inductors are arranged around the external inductor core. The inductor core comprises at least one cooling fluid conduit.

The present invention makes it possible to combine differential inductances and large common mode inductances into the same structure without increasing the physical size of the overall integrated inductor, especially compared to known differential-mode-only chokes constructed according to the known prior part. The possible core shapes help to maximize core area, avoid saturation issues and get more inductance in smaller space.

In a preferred embodiment of the invention, the internal inductor core has a triangular shape and/or the inductors are arranged in parallel to the sides of the internal triangular inductor core and/or the external inductor core has a hexagonal shape, wherein the inductor windings extend along straight central axes and/or have substantially constant pitches.

The shape of the internal inductor core does not have to be exactly triangular. For example, the corners of the triangle may be chamfered and/or obtuse. The shape of the outer sides of the internal inductor core may match the shape of the inner sides of the external inductor core, such that the internal inductor core may be inserted into the external inductor core with only minimal space between these two components.

In an alternative preferred embodiment of the invention, the internal inductor core has a circular shape and/or the external inductor core has a circular shape and/or the internal inductor core comprises at least one radially extending fin. Again, the internal and external inductor cores may have matching geometries for minimizing the space between said components. The fin or rather the fins may be provided at a position, where no inductors are provided. The fin may be a portion, at which the distance between the internal and external inductor cores is minimal. It may also be a portion at which the shape of the internal inductor core deviates from a circular shape.

In a preferred embodiment of the invention, the internal inductor core is split in three preferably identical core components separated by preferably symmetrical air gaps and/or three inductors are provided. One inductor may be provided adjacent to each core component.

In another preferred embodiment of the invention, the cooling fluid conduit is provided at the centre and/or at a radially outer portion of the internal inductor core. The cooling fluid conduit may comprise an inlet and an outlet fluid conduit portion. One single cooling fluid conduit may be provided for cooling the entire internal inductor core and in particular all of its core components. The internal inductor core may comprise internal fluid conduits for improving the distribution of the cooling fluid within the internal inductor core.

In another preferred embodiment of the invention, the internal inductor core is made of a ferro-magnetic material, such as iron powder, soft magnetic composite powder and/or soft magnetic mouldable composite. Suitable methods may be chosen for forming the rigid structure of the internal inductor core from the mentioned materials.

In another preferred embodiment of the invention, the inductors are situated between the internal inductor core on the inside and inductor cooling modules on the outside, wherein the inductor cooling modules are fluid cooling devices. The inside and outside direction may correspond to a radial direction of the integrated inductor. A fluid cooling may thus be provided on at least two sides of each inductor, namely radially inside and radially outside.

In a particularly preferred embodiment of the invention, at least one of the inductor cooling modules is pressed against its corresponding inductor by means of a pressing mechanism. The pressing mechanism ensures that sufficient contact between the inductor cooling modules and their corresponding inductors is provided.

In another preferred embodiment of the invention, the inductors are at a constant distance from the outer sides of the internal inductor core along the entire inductor lengths.

In another preferred embodiment of the invention, air gaps are provided between the internal inductor core and the external inductor core for tuning the inductor.

In another preferred embodiment of the invention, the cooling fluid conduct may be connected to a liquid cooled base via preferably a liquid conduit.

In another preferred embodiment of the invention, the inductor is electrically connected to an inductor busbar.

In a particularly preferred embodiment of the invention, the inductor busbar is mechanically fastened to an assembly bar.

### BRIEF DESCRIPTION OF THE DRAWINGS

Further details and advantages of the invention are described with reference to the embodiments shown in the figures. The figures show:

FIG. 1: a perspective side view of the integrated inductor 1;

FIG. 2: an internal view of the integrated inductor 1;

FIG. 3: a top view of the integrated inductor 1;

FIG. 4: a perspective view of the integrated inductor 1;

FIG. 5: another perspective view of the integrated inductor 1;

FIG. 6: a detailed view of the inductor cooling module;

FIG. 7: a partially exploded view of the integrated inductor 1;

FIG. 8: another partially exploded view of the integrated inductor 1;

FIG. 9: another partially exploded view of the integrated inductor 1;

FIG. 10: a detailed view of the enclosure 2;

FIG. 11: another partially exploded view of the integrated inductor 1;

FIG. 12: another side view of the integrated inductor 1;

FIG. 13: a detailed view of the internal inductor core;

FIG. 14: a detailed perspective view of the integrated inductor 1;

FIG. 15: a partially exploded view of the inside of the integrated inductor 1;

FIG. 16a: a detailed side view of the inside of the integrated inductor 1;

FIG. 16b: a circuit diagram of the integrated inductor 1;

FIG. 17: schematic diagram of inductor as known from the state of the art;

FIG. 18: another detailed side view of the inside of the integrated inductor 1;

FIG. 19: schematic representation of the flux distribution of the integrated inductor 1;

FIG. 20: another detailed side view of the inside of the integrated inductor 1;

FIG. 21: schematic representation of the air gap tuning of the integrated inductor 1; and

FIG. 22: schematic representation of the integrated inductor 1 with split internal inductor core 5.

### DETAILED DESCRIPTION

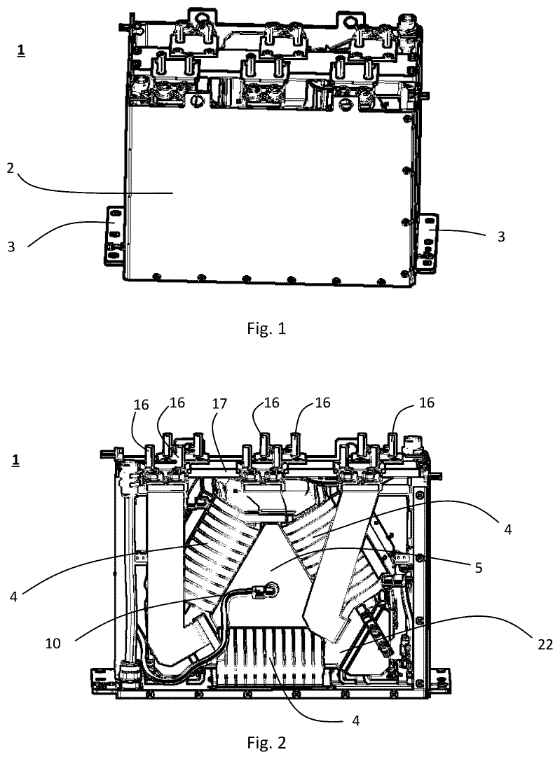

FIG. 1 is a perspective side view of the present invention's integrated inductor 1. The integrated inductor 1 may be regarded as a liquid cooled filter arrangement. The integrated inductor 1 may comprise an enclosure 2 and/or mounting brackets 3 for mechanically connecting the integrated inductor 1 to other structures.

FIG. 2 is an internal view of the integrated inductor 1, with a centrally positioned internal inductor core 5 or single core triangle 5. In the embodiment shown, the internal inductor core 5 is of a substantially triangular shape. It is surrounded by three inductors 4, one at each side of the triangular internal inductor core 5. A number of busbar connecting bolts 16 is provided for electrically connecting the components inside the integrated inductor 1 to some outside power source and/or electric device, such as an active front end converter LCL filter or frequency converter sine filter.

An external inductor core 22 is situated around the internal inductor core 5 but only partially visible, as it is largely provided within the inductors 4. The inductors 4 are arranged around the external inductor core 22. The three inductors 4 shown in FIG. 2 may be angled at 60° with respect to each other.

The inductor core 5 may comprise at least one cooling fluid conduit 10 or inductor core hole 10 for providing cooling fluid to the inside of the inductor core 5. The inductor core hole 10 may be a single inductor core hole 10 with only one opening or an inductor core though hole 10 with two openings. The cooling fluid conduit 10 may lead though the centre of the internal inductor core 5 and/or may comprise openings at opposite sides of the internal inductor core 5. In the case of a single inductor core hole 10, a heat pipe may be inserted into the single inductor core hole 10 as a cooling device.

The cooling fluid conduit 10 may be provided at the centre and/or at a radially outer portion of the internal inductor core 5. The cooling fluid conduit 10 may comprise an inlet and an outlet fluid conduit portion, which are separate from each other. The inlet and outlet fluid conduit portion may be provided at opposite sides of the internal inductor core 5 and preferably at central locations of the internal inductor core 5. Alternatively, a single inlet and outlet fluid conduit may be provided at one side of the internal inductor core 5, combining two fluid conduits at the same component. One single cooling fluid conduit 10 may be provided for cooling the entire internal inductor core 5 and in particular all of its core components.

The inductors 4 may be arranged in parallel to the sides of the internal triangular inductor core 5. The inductors 4 may comprise windings, which are wound around a linear axis, wherein the axis is preferably oriented in parallel to the outer edges of the internal inductor core 5.

The internal inductor core 5 may be made of a ferromagnetic material, such as iron powder, soft magnetic composite powder and/or soft magnetic mouldable composite. Suitable methods may be chosen for forming the rigid structure of the internal inductor core 5 from the mentioned materials.

The inductors 4 are shown at a constant distance from the outer sides of the internal inductor core 5 along the entire inductor 4 lengths. The windings of the inductors 4 are shown to be of constant pitch. The windings may be wound around a linear axis instead of a curved axis, as is often the case according to the prior art.

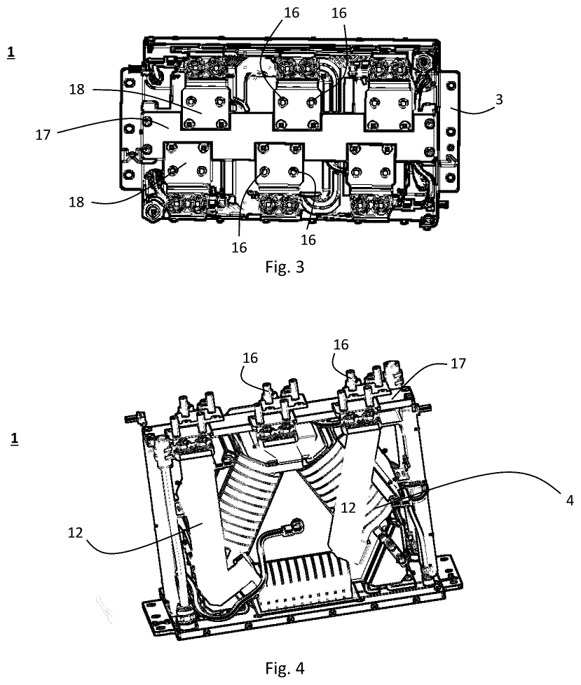

FIG. 3 is a top view of the integrated inductor 1. An assembly bar 17 is shown just below the busbar connecting bolts 16. The busbar connecting bolts 16 may be the uppermost portion of the integrated inductor 1. In total 24 such busbar connecting bolt 16 may be provided, arranged in six groups of four busbar connecting bolts 16 each. The busbar connecting bolts 16 may be provided on a number of connecting brackets 18. The connecting brackets 18 may be directly or indirectly connected to the assembly bar 17.

In the embodiment of FIG. 3, six connecting brackets 18 are provided, one for each group of four busbar connecting bolts 16. Protruding from the sides of the integrated inductor 1, two mounting brackets 3 are shown, arranged opposite each other and on short sides of the substantially rectangular base of the integrated inductor 1.

FIG. 4 is a perspective view of the integrated inductor 1. The busbar connecting bolts 16 are shown in close proximity to the assembly bar 17. The connecting bolts 16 may be arranged perpendicular to the assembly bar 17. The connecting bolts 16 make it possible to electrically connect an inductor busbar 12 of the integrated inductor 1 to some external appliance. The inductors 4 may be electrically connected to said inductor busbar 12. In the embodiment of FIG. 4, two inductor busbars 12 are shown on the front side of the integrated inductor 1. However more inductor busbars 12 may be provided, for example on the rear side of the integrated inductor 1. In any case, the inductor busbar 12 may be mechanically fastened to the assembly bar 17.

FIG. 5 is another perspective view of the integrated inductor 1. The individual inductors 4 are shown situated between the internal inductor core 5 on the inside and inductor cooling modules 8 or a liquid cooled base 14 on the outside, wherein the inductor cooling modules 8 are fluid cooling devices. A fluid cooling may thus be provided on at least two sides of each inductor 4, namely radially inside and radially outside. The radial direction may be referenced to the position of the internal inductor core 5, wherein the position of the internal inductor core 5, preferably its centre, may define the radially central position. The radial direction may extend in a plane defined by the triangular cross-section of the internal inductor core 5.

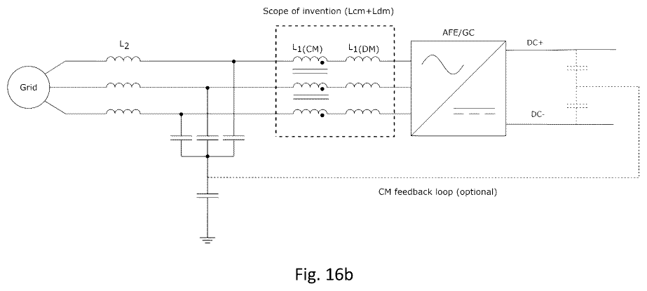

Each of the individual inductors 4 may be adjacent to its corresponding inductor cooling module 8 or the liquid cooled base 14. The number of the individual inductors 4 may therefore be equal to the number of cooling modules 8 plus the liquid cooled base 14. At least one of the inductor cooling modules 8 may be pressed against its corresponding inductor 4 by means of a pressing mechanism 24, shown in FIG. 16a.

The cooling fluid conduct 10 may be connected to the liquid cooled base 14 via preferably a liquid conduit 7. Further liquid conduits 7 may provide fluid connections between any relevant parts of a cooling system. The inductor busbars 12 may be aligned on the outer sides of the integrated inductor 1, preferably in parallel to a plane defined by the triangular side of the internal inductor core 5. Liquid connectors 6 may be provided for connecting the liquid cooled base 14 and/or the inductor cooling module 8 to further components of the cooling system.

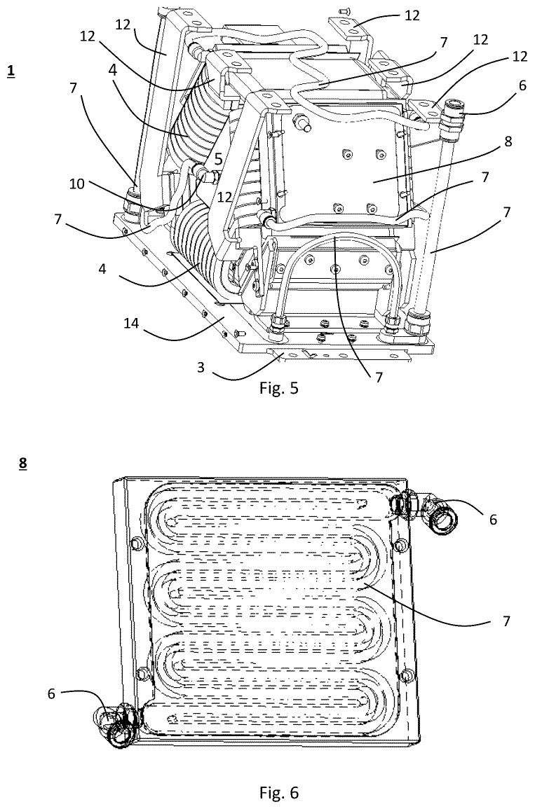

FIG. 6 is a detailed view of the inductor cooling module 8. Liquid conduits 7 may be provided within the inductor cooling module 8 and/or may be arranged in an undulated pattern. Preferably two liquid connectors 6 may extend in a substantially perpendicular direction with respect to the planar inductor cooling module 8. The inductor cooling module 8 may be of a rectangular shape, wherein the liquid connectors 6 may be provided at two opposite corners of the inductor cooling module 8.

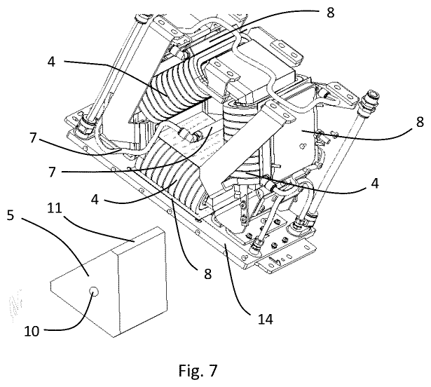

FIG. 7 is a partially exploded view of the integrated inductor 1. Three inductor cooling modules 8 are shown arranged at an angle to each other and in parallel to their respective individual inductor 4. The inductor cooling modules 8 are arranged adjacent to each of their respective individual inductor 4. One of the inductor cooling modules 8 is provided between its inductor 4 and the liquid cooled base 14. Here, three cooling modules 8 are provided, one for each inductor 4.

Liquid conduits 7 connect the internal inductor core 5 to a liquid coolant supply. In the partially exploded view of FIG. 7, the internal inductor core 5 is shown next to the remainder of the integrated inductor 1, i.e. not in its readily assembled working position. The internal inductor core 5 comprises the inductor core hole 10 and inductor core edges 11. The inductor core edges 11 may correspond to chamfers at the three corners of the substantially triangular internal inductor core 5.

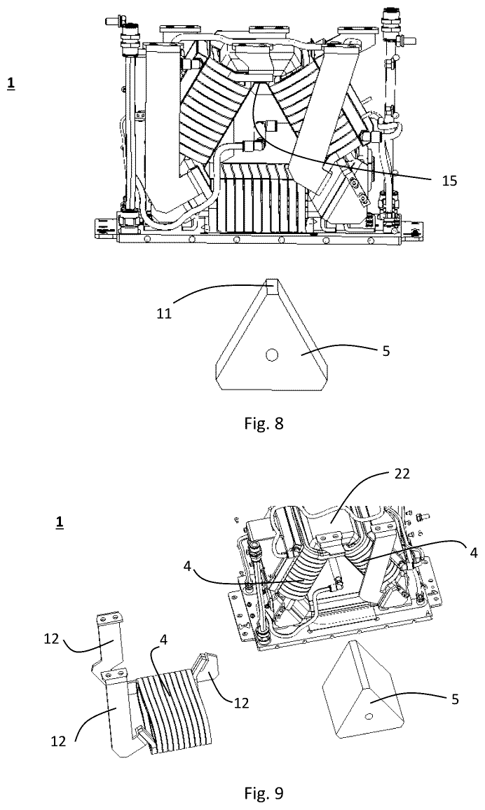

FIG. 8 is another partially exploded view of the integrated inductor 1. An inductor core internal edge 15 is shown for accommodating the inductor core edges 11 of the internal inductor core 5. As seen in FIGS. 7 and 8, the shape of the internal inductor core 5 does not have to be exactly triangular. For example, the corners of the triangle may be chamfered and/or obtuse. The shape of the outer sides of the internal inductor core 5 may match the shape of the inner sides of the external inductor core 22, such that the internal inductor core 5 may be inserted into the external inductor core 22 with only minimal remaining space between these two components.

FIG. 9 is another partially exploded view of the integrated inductor 1. The external inductor core 22 is shown with two of its surrounding individual inductors 4. The internal inductor core 5 is shown adjacent to the external inductor core 22 and next to the busbar 12 arrangement.

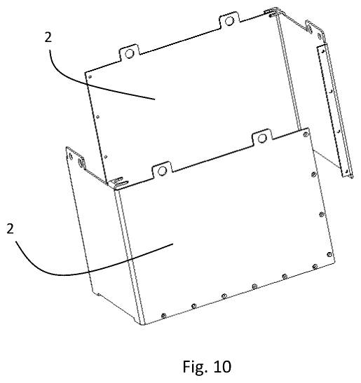

FIG. 10 is a detailed view of the enclosure 2. The enclosure 2 may comprise two similar or identical sub-portions, which may be connected to the remainder of the integrated inductor 1. The sub-portions may be L-shaped, with two enclosure surfaces arranged to each other at right angles.

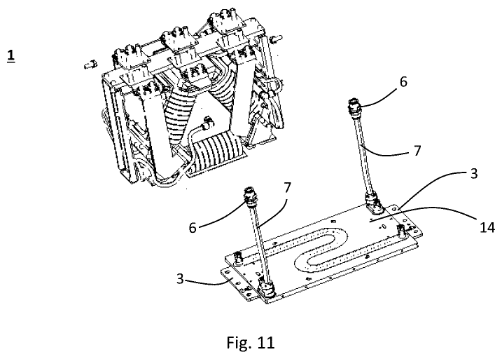

FIG. 11 is another partially exploded view of the integrated inductor 1. The liquid cooled base 14 is shown separated from the remainder of the integrated inductor 1. The liquid cooled base 14 is of a rectangular shape and is a flat component, extending in a plane. The liquid cooled base 14 comprises two mounting brackets 3 at its two opposite shorter edges. Close to the brackets 13 and in two opposite corners of the rectangular liquid cooled base 14, two liquid conduits 7 are provided, each comprising a liquid connector 6 at its free end.

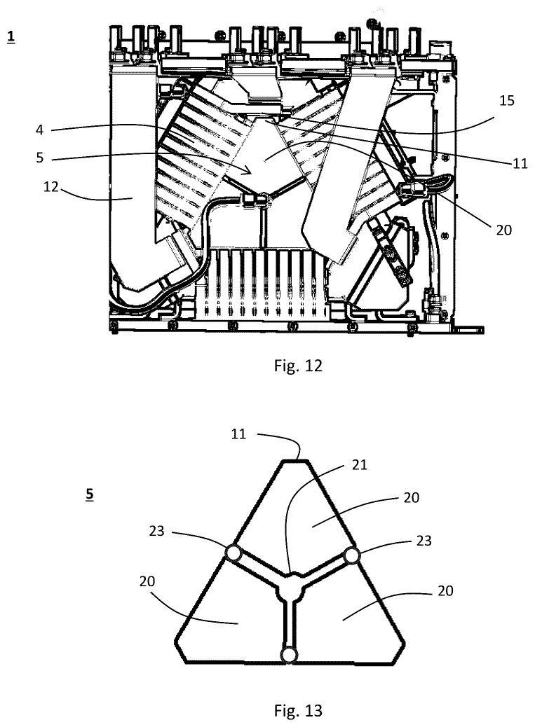

FIG. 12 is another side view of the integrated inductor 1. The inductor core 5 is shown to be split in three preferably identical inductor core split triangles 20 or core components 20. Each of the inductor core split triangles 20 comprises one inductor core edge 11 pointing radially outwards of the inductor core 5. The radial direction may be referenced to the centre of the inductor core 5 and may extend in the plane of the inductor core 5 as shown in FIG. 12. Inductor busbars 12 and inductors 4 are shown for reference. One or preferably two inductors 4 may be provided at each core component 20. Two different inductor 4 at a core component 20 may be angled to each other and may surround an inductor core edge 11 of the core component 20.

FIG. 13 is a detailed view of the internal inductor core 5 shown in FIG. 12. The inductor core 5 is shown split in three inductor core split triangles 20 or core components 20. At the centre of the inductor core 5, an inductor core split shape hole 21 is provided as a cooling fluid connection. Alternatively or additionally, inner core cooling conduits 23 may be placed next to the windings of the inductor 4 on each side of the internal inductor core 5. This arrangement can provide cooling to the internal core 5 and to the windings of the inductor 4. The internal inductor core 5 is split in three preferably identical core components 20, which may be separated by preferably symmetrical air gaps. The inner core cooling conduits 23 may be arranged in these air gaps. The internal inductor core 5 may comprise further internal fluid conduits for better distribution of the cooling fluid inside the internal inductor core 5.

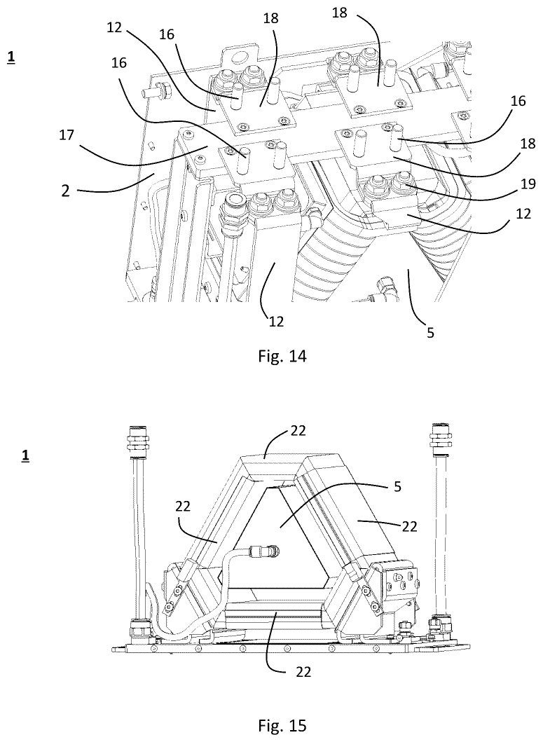

FIG. 14 is a detailed perspective view of the integrated inductor 1. A portion of the enclosure 2 is shown at the rear of the integrated inductor 1. The internal inductor core 5 is shown at the bottom right of the figure. Inductor busbars 12 are shown at various positions of the integrated inductor 1. The inductor busbars 12 terminate at busbar connecting bolts 16 for electrically connecting the busbars 12 to external structures. The inductor busbars 12 and the busbar connecting bolts 16 may be connected to connecting brackets 18, preferably via fastener 19.

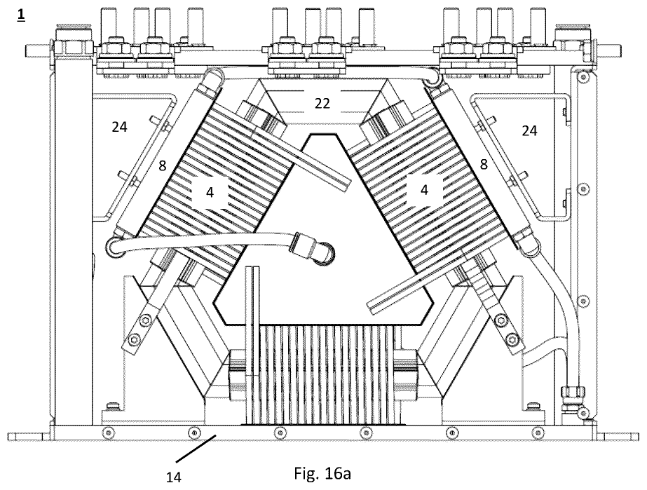

FIG. 15 is a partially exploded view of the inside of the integrated inductor 1. The internal conductor core 5 is shown surrounded by the external inductor core 22 of matching size and shape.

FIG. 16a is a detailed side view of the inside of the integrated inductor 1. The hexagonal shape of the external inductor core 22 is shown. The external inductor core 22 comprises three long portions and three short portions. The external inductor core 22 is oriented such that one of its long portions aligns in parallel with an outer wall of the integrated inductor 1 and one of its short portions aligns with an opposite outer wall of the integrated inductor 1. The inductor 4 windings extend along straight central axes, wherein the central axis are positioned along the centre lines of the long portions of the external inductor core 22. The inductor 4 windings have substantially constant pitches.

The pressing mechanism 24 presses against the inductor cooling modules 8 and ensures that sufficient contact between the inductor cooling modules 8 and their corresponding inductors 4 is provided. Two pressing mechanisms 24 may be provided, pressing against the internal inductor core 5 and the liquid cooled base 14.

FIG. 16b is a circuit diagram of the integrated inductor 1. The differential mode and common mode inductances at the core of the invention are shown connecting the active front end to the grid.

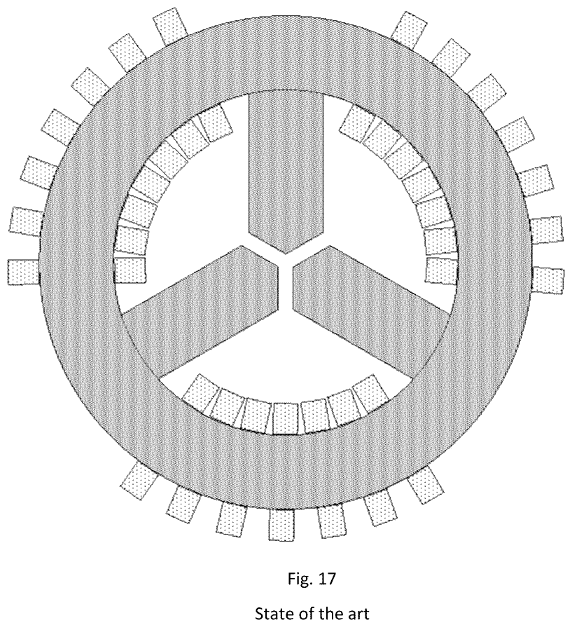

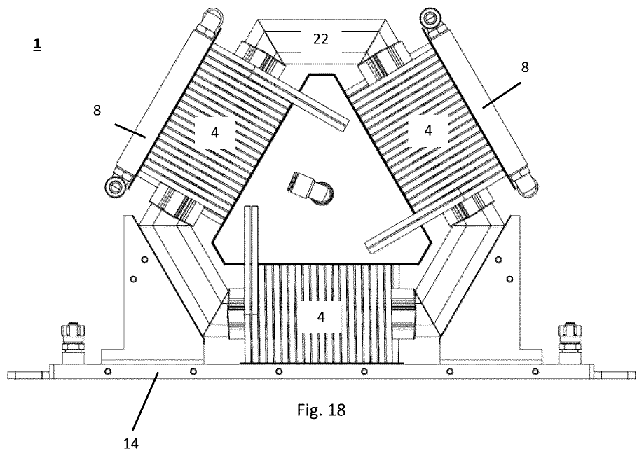

FIG. 17 is a schematic diagram of inductor as known from the state of the art. The circular or sometimes hexagonal shape of state of the art inductors and the mismatch between the internal and external inductor cores leads to a number of problems in high current applications:

The use of foil windings is complicated. The circular shape makes it necessary to bend flat wire windings into a circular form, which wastes space on the outside layer, while the inside layer is tightly packed. Furthermore, the circular bending process is rather intricate and not as common as providing windings on rectangular rather than circular shapes. The circular winding layout necessitates a correspondingly shaped winding heat sink, as flat and/or rectangular heat sinks will show insufficient efficiencies. As the centre legs typically have not thermal contact inside the structure, they required dedicated heat sinks. These dedicated heat sinks will interfere with the air gap fringing flux, causing eddy current losses. Also, the centre leg thickness has to be sufficiently large to avoid saturation from differential currents, taking space from the windings on the inner ring. Accordingly, the inner ring dimensions have to be relatively large.

FIG. 18 is another detailed side view of the inside of the integrated inductor 1. Three inductor coils 4 are shown arranged around the external inductor core 22. The liquid cooled base 14 is shown at the bottom of the arrangement. Further inductor cooling modules 8 are shown arranged at an angle to the liquid cooled base 14.

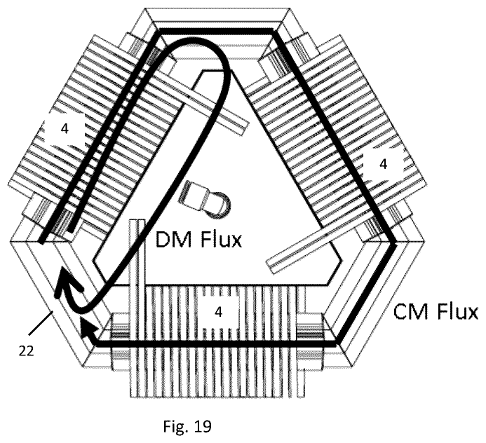

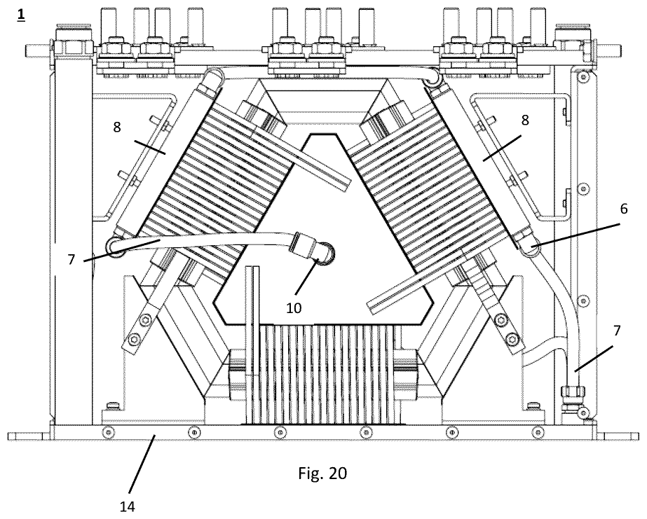

FIG. 19 is a schematic representation of the flux distribution of the integrated inductor 1. The differential mode flux or DM flux is shown at one of the inductors 4. Similar or identical DM fluxes may be provided at all present inductors 4. The common mode flux of CM flux is shown at the entire external inductor core 22. DM and CM fluxes are shown to be aligned in parallel and in the same direction along the external inductor core 22.

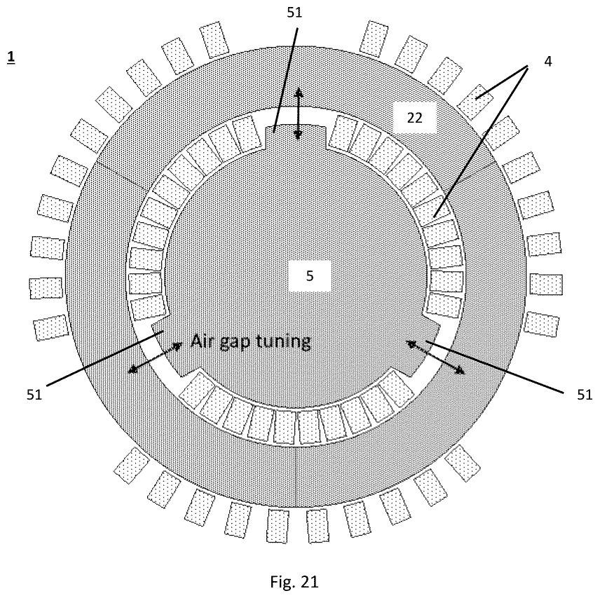

FIG. 20 is another detailed side view of the inside of the integrated inductor 1. Here, the various cooling components are shown connected fluidly to each other. Liquid conduits 7 fluidly connect the liquid cooled base 14 to the inductor cooling modules 8 and one of the inductor cooling modules 8 to the inductor core through hole 10.

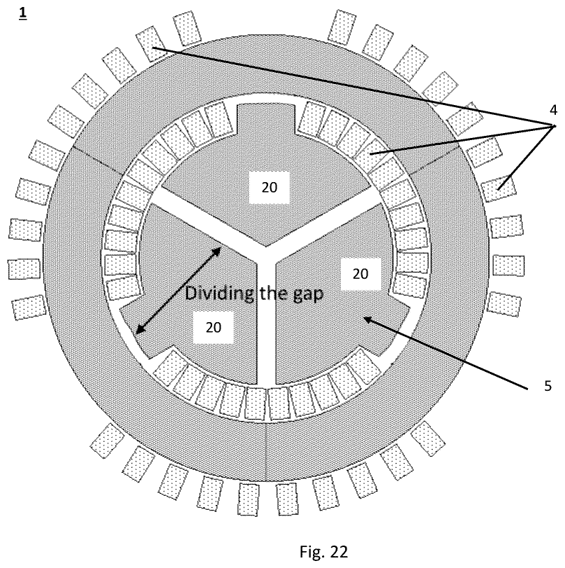

FIG. 21 is a schematic representation of the air gap tuning of the integrated inductor 1. In this embodiment, the internal inductor core 5 has a circular shape and the external inductor core 22 has a corresponding circular shape. The internal inductor core 5 comprises at least one and preferably three radially extending fins 51. The radially extending fins 51 may be aligned at 120° angles with respect to each other. The internal and external inductor cores 5, 22 may have a matching geometry for minimizing the space between said components. The fins 51 may be provided at positions, where no inductors 4 are provided. The fins 51 may be portions of the internal inductor core 5, at which the distance between the internal and external inductor cores 5, 22 is minimal. The air gaps are provided between the internal inductor core 5 and the external inductor core 22 for tuning the inductor.

FIG. 22 is a schematic representation of the integrated inductor 1 with split internal inductor core 5. As in the embodiment shown in FIG. 21, a circular geometry of the internal inductor core 5 and the external inductor core 22 has been chosen. This time, the internal inductor core 5 is split in three preferably identical core components 20 separated by preferably symmetrical air gaps. As in the embodiment of figure, 21, three inductors 4 are provided. Parts of two inductors 4 may be provided at each core component 20. The air gaps between the core components 20 may be divided for tuning the integrated inductor 1.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. An integrated differential mode and common mode inductor, preferably for an active front end converter LC(L) filter or frequency converter sine filter, comprising an internal inductor core and inductors arranged around an external inductor core, wherein the inductor core comprises at least one cooling fluid conduit.

2. The integrated differential mode and common mode inductor according to claim 1, wherein the internal inductor core has a triangular shape and/or that the inductors are arranged in parallel to the sides of the internal triangular inductor core and/or that the external inductor core has a hexagonal shape, wherein the inductor windings extend along straight central axes and/or have substantially constant pitches.

3. The integrated differential mode and common mode inductor according to claim 1, wherein the internal inductor core has a circular shape and/or the external inductor core has a circular shape and/or that the internal inductor core comprises at least one radially extending fin.

4. The integrated differential mode and common mode inductor according to claim 1, wherein the internal inductor core is split in three preferably identical core components separated by preferably symmetrical air gaps and/or that three inductors are provided.

5. The integrated differential mode and common mode inductor according to claim 1, wherein the cooling fluid conduit is provided at the centre and/or at a radially outer portion of the internal inductor core.

6. The integrated differential mode and common mode inductor according to claim 1, wherein the internal inductor core is made of a ferromagnetic material, such as iron powder, soft magnetic composite powder and/or soft magnetic mouldable composite.

7. The integrated differential mode and common mode inductor according to claim 1, wherein the inductors are situated between the internal inductor core on the inside and inductor cooling modules on the outside, wherein the inductor cooling modules are fluid cooling devices.

8. The integrated differential mode and common mode inductor according to claim 7, wherein at least one of the inductor cooling modules is pressed against its corresponding inductor by means of a pressing mechanism.

9. The integrated differential mode and common mode inductor according to claim 1, wherein the inductors are at a constant distance from the outer sides of the internal inductor core along the entire inductor lengths.

10. The integrated differential mode and common mode inductor according to claim 1, wherein air gaps are provided between the internal inductor core and the external inductor core for tuning the inductor.

11. The integrated differential mode and common mode inductor according to 1, wherein the cooling fluid conduct may be connected to a liquid cooled base via preferably a liquid conduit.

12. The integrated differential mode and common mode inductor according to claim 1, wherein the inductor is electrically connected to an inductor busbar.

13. The integrated differential mode and common mode inductor according to claim 12, wherein the inductor busbar is mechanically fastened to an assembly bar.

14. The integrated differential mode and common mode inductor according to claim 2, wherein the internal inductor core is split in three preferably identical core components separated by preferably symmetrical air gaps and/or that three inductors are provided.

15. The integrated differential mode and common mode inductor according to claim 3, wherein the internal inductor core is split in three preferably identical core components separated by preferably symmetrical air gaps and/or that three inductors are provided.

16. The integrated differential mode and common mode inductor according to claim 2, wherein the cooling fluid conduit is provided at the centre and/or at a radially outer portion of the internal inductor core.

17. The integrated differential mode and common mode inductor according to claim 3, wherein the cooling fluid conduit is provided at the centre and/or at a radially outer portion of the internal inductor core.

18. The integrated differential mode and common mode inductor according to claim 4, wherein the cooling fluid conduit is provided at the centre and/or at a radially outer portion of the internal inductor core.
